(19) United States
(12) Patent Application Publication
(10) Pub. No.: US 2025/0242374 A1
(43) Pub. Date: Jul. 31, 2025

(54) SPRAYER GUN CONNECTING STRUCTURE

(71) Applicant: SHIN TAI SPURT WATER OF THE GARDEN TOOLS CO., LTD, Lukang Township (TW)

(72) Inventor: Chin-Yuan CHEN, Lukang Township (TW)

(21) Appl. No.: 18/427,803

(22) Filed: Jan. 30, 2024

(51) Int. Cl. B05B 15/65; B05B 9/01

(52) U.S. Cl. CPC B05B 15/65; B05B 9/01

(57) ABSTRACT

A sprayer gun connecting structure has a sprayer gun, an assembling member, and a sealing washer. The sprayer gun has a plastic main body with an intake end, the intake end has two opposing L-shaped rotatable slots on an outer periphery, and each rotatable slot has an opening section and an engaging section passing through the main body. The assembling member is made of metal and comprises a through aperture, the through aperture having a threaded section on an inner wall, and two opposing latches are respectively disposed on an outer periphery of the assembling member. The opening section of each rotatable slot is configured to accept at least one of the latches of the assembling member and being rotatable to lock the latch in the engaging section to assemble the assembling member on the intake end of the sprayer gun.

### BACKGROUND OF INVENTION

### Field of Invention

The present invention relates to a sprayer gun connecting structure, and more particularly to sprayer gun connecting structure with light weigth.

### Description of the Related Art

During gardening work, it is necessary to water the flowers and trees regularly to avoid the death of plants due to lack of water and dryness. Usually, the plants are planted in a wide range area or far away from the water source, so the watering process uses water hoses. But the water directly flowing out of the water hose has a stronger flow and small range, which makes it impossible to water a large area, and the watering process is slow. Therefore, it is necessary to install a water spray gun at the end of the water hose for use. The water spray gun can spray water in a large area to achieve more efficient and comprehensive irrigation. Conventional sprayer guns all have main bodies made of metal zinc alloy, the intake end of the main body is equipped with the threaded section so that the threaded section can provide water pipes for connection, and the outer surface of the main body is combined with a grip cover made by plastic injection coating.

However, the above conventional structure still has the following problems in practical application: the main body is entirely made of metal, so not only is the production cost high, but the overall weight is also heavy. And the problem of being unable to meet the lightweight requirements.

Therefore, it is desirable to provide a sprayer gun connecting structure to mitigate and/or obviate the aforementioned problems.

### SUMMARY OF THE INVENTION

An objective of present invention is to provide a sprayer gun connecting structure which is capable of improving the above-mention problems.

In order to achieve the above mentioned objective, a sprayer gun connecting structure has a sprayer gun, an assembling member, and a sealing washer. The sprayer gun has a plastic main body with an intake end, the intake end has two opposing L-shaped rotatable slots on an outer periphery, and each rotatable slot has an opening section and an engaging section passing through the main body. The assembling member is made of metal and comprises a through aperture, the through aperture having a threaded section on an inner wall, and two opposing latches are respectively disposed on an outer periphery of the assembling member. The opening section of each rotatable slot is configured to accept at least one of the latches of the assembling member and being rotatable to lock the latch in the engaging section to assemble the assembling member on the intake end of the sprayer gun.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combination drawing of a preferred embodiment according to the present invention.

FIG. 2 is a three-dimensional exploded view of the preferred embodiment according to the present invention.

FIG. 3 shows the rotation engagement of the preferred embodiment according to the present invention.

FIG. 4 is a cross-sectional view after the rotation engagement of the preferred embodiment according to the present invention.

FIG. 5 is a cross-sectional view of the grip cover after completion of injection coating according to the present invention.

FIG. 6 shows a water pipe connection be connected the preferred embodiment according to the present invention.

### DETAILED DESCRIPTION OF THE PREFERRED EMBODIMENT

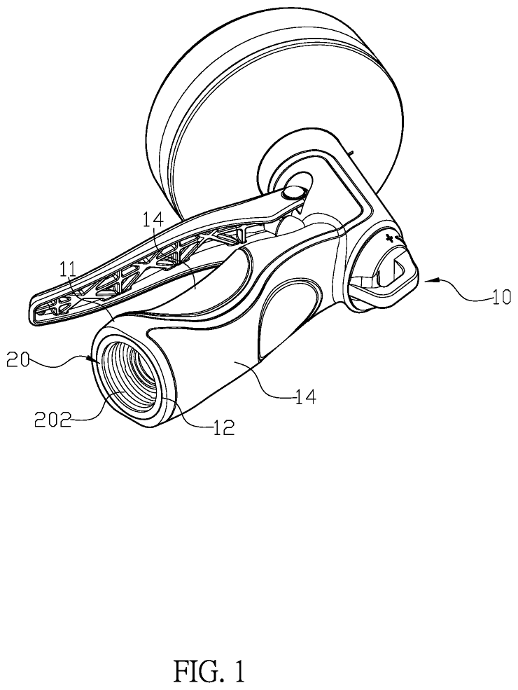

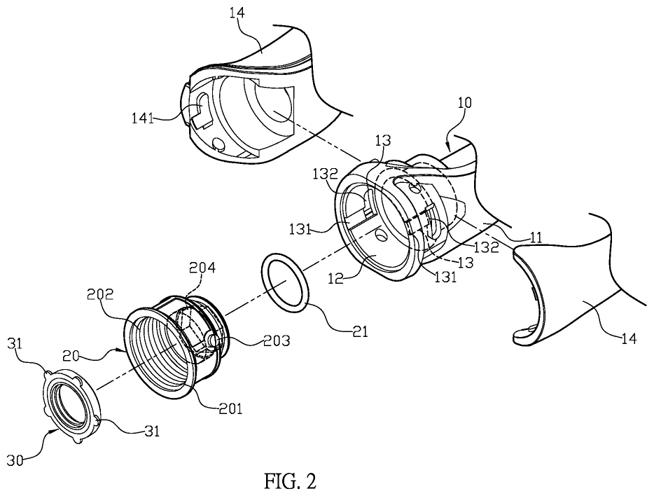

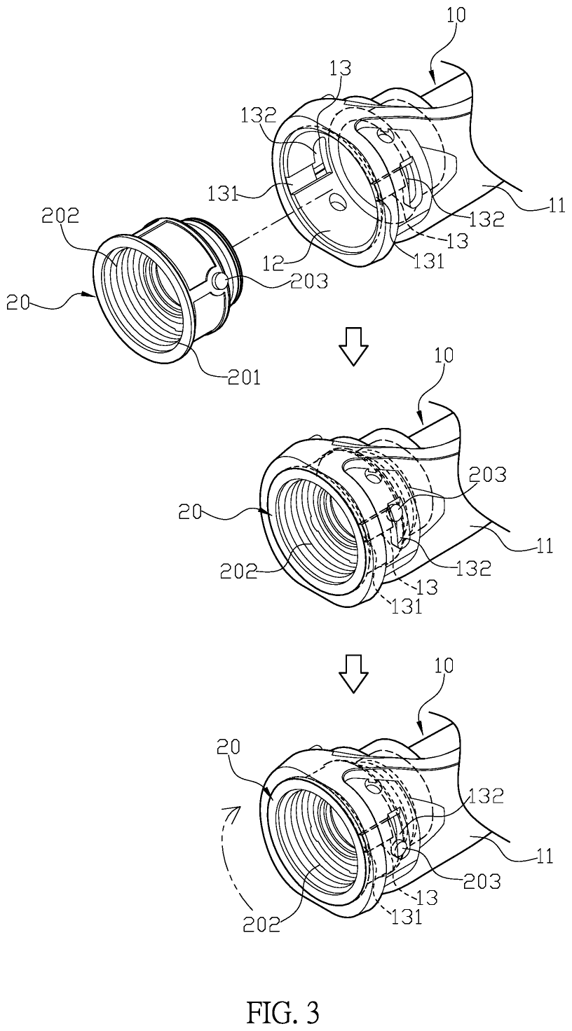

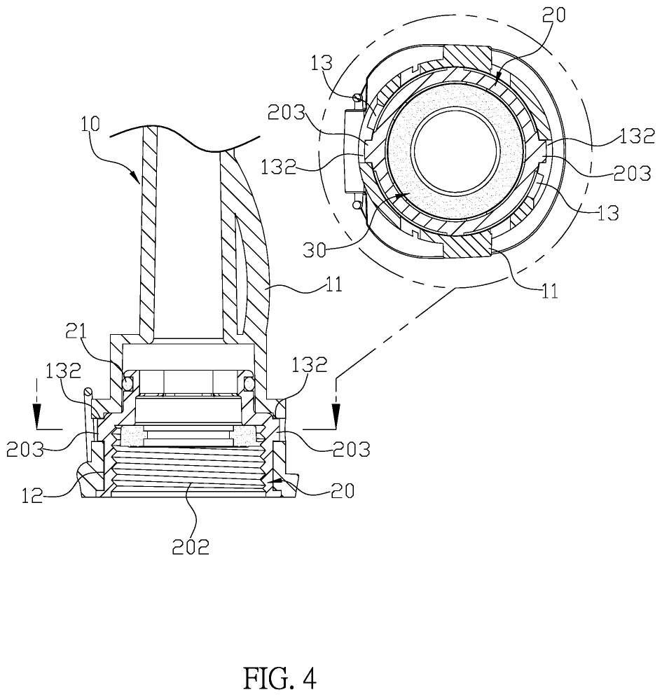

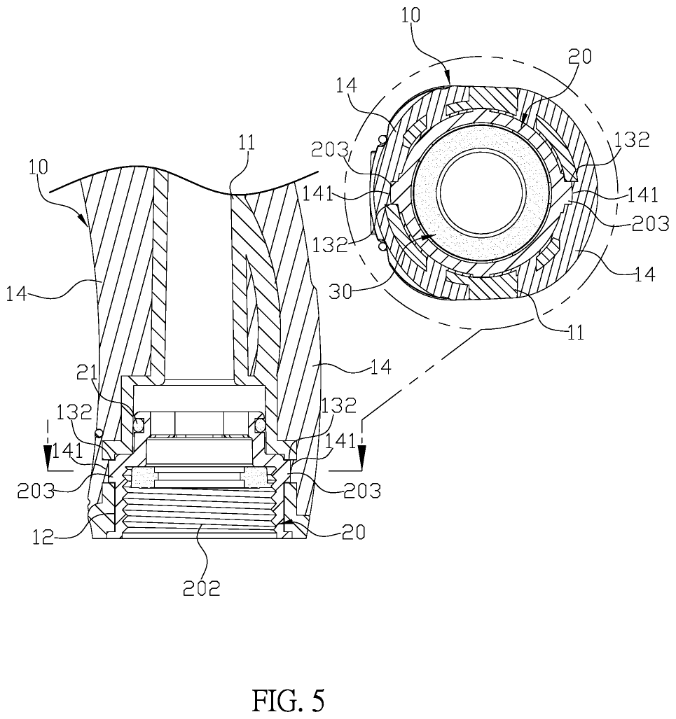

First, please refer to FIG. 1 and FIG. 2. A sprayer gun connecting structure comprises a sprayer gun 10, an assembling member 20 and a sealing washer 30. The sprayer gun 10 comprises a plastic main body 11 with an intake end 12 having two opposing L-shaped rotatable slots 13 on an outer periphery. Each rotatable slot 13 has a opening section 131 and an engaging section 132 passing through the main body 11. The assembling member 20 is made of metal and comprises a through aperture 201, and the through aperture 201 has a threaded section 202 on an inner wall. Furthermore, two opposing latches 203 respectively disposed on an outer periphery of the assembling member 20. The opening section 131 of each rotatable slot 13 is configured to accept at least one of the latches 203 of the assembling member 20 and being rotatable to lock the latch 203 in the engaging section 132 as shown in FIG. 3, to assemble the assembling member 20 on the intake end 12 of the sprayer gun 10. As shown in FIG. 4, after the assembling member 20 is installed on the intake end 12, a grip cover 14 is formed to covered the main body 11 by a plastic injection coating process, and the engaging section 132, the rotatable slots 13 and the latches 20 are also covered which forms a protruding edge 141, as shown in FIG. 5, such that the assembling member 20 is fully combined with the main body 11 by being rotated and then covered. Furthermore, the sealing washer 30 is installed in the through aperture 201 to protect the threaded section 202 of the assembling member 20 from water

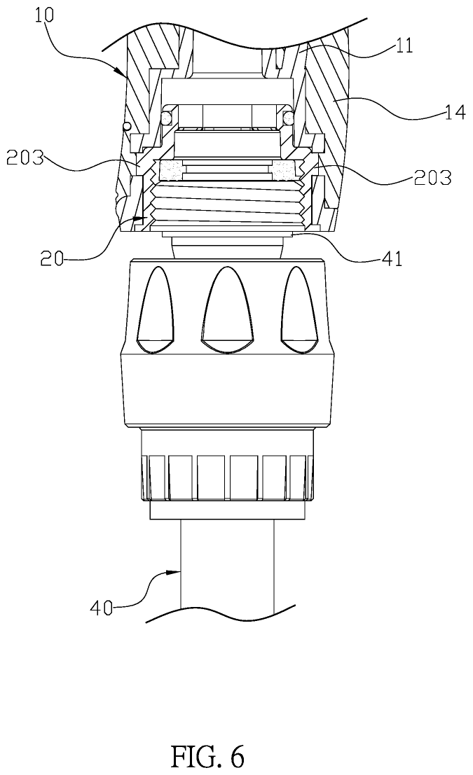

Please refer to FIG. 6 for actual operation. The threaded section 202 of the assembling member 20 is configured for being connected to a joint 41 installed at an end of the water pipe 40 as a screw lock, so that the sealing washer 30 can be clamped between the joint 41 and the assembling member 20 via the combination between the water pipe 40 and the sprayer gun 10 and the sprayer gun 10 successfully obtain the supply of water.

In addition, the grip cover 14 is softer and more flexible than the main body 11, which allows the sprayer gun 10 to provide a more comfortable grip.

Also, the assembling member 20 is made of zinc alloy.

Moreover, the assembling member 20 is jacketed with a seal ring.21.

Additionally, the through aperture 201 comprises a larger first aperture and a smaller second aperture, such that the threaded section 202 is provided on the first aperture and the second aperture has a polygonal shape 204 for engaging with a hand tool.

Furthermore, the sealing washer 30 further comprises a plurality of fins 31, and the fins 31 are arranged in a petal arrangement.

With the structure of the above specific embodiment, the following benefits can be obtained: only the assembling member 20 of the sprayer gun 10 is configured for being connected to the water pipe 40 and is made of metal, while the main body 11 is made by plastic injection molding process, which not only lowers the production cost, but the overall weight of the sprayer gun 10 can be reduced to the lightest level.

Although the present invention has been explained in relation to its preferred embodiment, it is to be understood that many other possible modifications and variations can be made without departing from the spirit and scope of invention as hereinafter claimed.

What is claimed is:

1. A sprayer gun connecting structure comprising: a sprayer gun, an assembling member, and a sealing washer; wherein:
the sprayer gun comprises a plastic main body with an intake end, the intake end having two opposing L-shaped rotatable slots on an outer periphery, each rotatable slot having an opening section and an engaging section passing through the main body;
the assembling member is made of metal and comprises a through aperture, the through aperture comprising a threaded section on an inner wall, two opposing latches respectively disposed on an outer periphery of the assembling member; the opening section of each rotatable slot is configured to accept at least one of the latches of the assembling member and being rotatable to lock the latch in the engaging section to assemble the assembling member on the intake end of the sprayer gun; wherein after the assembling member is installed on the intake end, a grip cover is formed to cover the main body by a plastic injection coating process, and the engaging section, the rotatable slots and the latches are also covered which forms a protruding edge; and the sealing washer is installed in the through aperture to protect the threaded section of the assembling member from water.

2. The sprayer gun connecting structure as claimed in claim 1, wherein the assembling member is made of zinc alloy.

3. The sprayer gun connecting structure as claimed in claim 1, wherein the assembling member is jacketed with a seal ring.

4. The sprayer gun connecting structure as claimed in claim 1, wherein the through aperture comprises a larger first aperture and a smaller second aperture, such that the threaded section is provided on the first aperture and the second aperture has a polygonal shape.

5. The sprayer gun connecting structure as claimed in claim 1, wherein the sealing washer further comprises a plurality of fins.
